(19) United States
(12) Patent Application Publication
(10) Pub. No.: US 2025/0077148 A1
(43) Pub. Date: Mar. 6, 2025

(54) INFORMATION PROCESSING METHOD, INFORMATION PROCESSING APPARATUS, AND STORAGE MEDIUM

(71) Applicant: CANON KABUSHIKI KAISHA, Tokyo (JP)

(72) Inventor: Yuuka Hirosugi, Kanagawa (JP)

(21) Appl. No.: 18/814,776

(22) Filed: Aug. 26, 2024

(30) Foreign Application Priority Data
Aug. 30, 2023 (JP) 2023-139930

(51) Int. Cl. G06F 3/12

(52) U.S. Cl. CPC G06F 3/127; G06F 3/1205

(57) ABSTRACT

Provided is an information processing method including: an obtaining step of obtaining print data containing first print setting information representing setting information of printing, second print setting information representing a current print setting in a printing apparatus intended to print the print data, and third print setting information applied to a hot folder corresponding to the printing apparatus; and a notification step of making a predetermined notification based on the first print setting information, the second print setting information, and the third print setting information.

### BACKGROUND OF THE INVENTION

### Field of the Invention

The present disclosure relates to a technique to make a notification of whether printing is suitable.

### Description of the Related Art

In the commercial printing field, printing apparatuses have used a hot folder system. The hot folder system works as follows: when a print job file is submitted to a particular folder, an instruction is sent to a printing apparatus to execute printing using print settings applied to the particular folder. At the process of submitting a print job file to a hot folder, the user cannot know whether the printing apparatus corresponding to the hot folder is able to print the print job file with print settings applied to the hot folder.

Japanese Patent Laid-open No. 2021-114203 (Literature 1) discloses a method of determining whether printing can be performed, by comparing print settings applied to a hot folder with state information of the printing apparatus corresponding to the hot folder and notifying the user.

However, the method of Literature 1 has a problem that the user cannot recognize that the print settings applied to the hot folder and the state of the printing apparatus corresponding to the hot folder are unsuitable for printing of the print job file.

### SUMMARY OF THE INVENTION

An information processing method according to an aspect of the present disclosure includes: an obtaining step of obtaining print data containing first print setting information representing setting information of printing, second print setting information representing a current print setting in a printing apparatus intended to print the print data, and third print setting information applied to a hot folder corresponding to the printing apparatus; and a notification step of making a predetermined notification based on the first print setting information, the second print setting information, and the third print setting information.

Further features of the present invention will become apparent from the following description of exemplary embodiments with reference to the attached drawings.

### BRIEF DESCRIPTION OF THE DRAWINGS

FIG. 1 is a block diagram illustrating an example of the hardware configuration of a printing system;

FIG. 2 is a block diagram illustrating an example of the hardware configuration of a printing apparatus;

FIG. 3 is a diagram illustrating an example of the configuration of a printing application;

FIGS. 4A and 4B are diagrams illustrating examples of the user interface of the printing application;

FIG. 5 is a diagram illustrating an example of a printer information folder registration screen;

FIG. 6 is a diagram illustrating an example of a hot folder list registration screen.

FIG. 7 is diagram showing the relationship of FIG. 7A and FIG. 7B, FIGS. 7A and 7B are a flowchart illustrating an example of a printing suitability determination process;

FIG. 8 is a diagram illustrating an example of a dialog box to make a notification of results of the printing suitability determination process;

FIG. 9 is a diagram illustrating an example of items to be determined in the printing suitability determination process;

FIG. 10 is a flowchart illustrating an example of main processing of the printing suitability determination process;

FIGS. 11A and 11B are diagrams illustrating an example of indication items to make a notification of results of the printing suitability determination process; and

FIG. 12 is a diagram illustrating an example of a hot folder registration screen.

### DESCRIPTION OF THE EMBODIMENTS

Hereinafter, preferred embodiments of the present disclosure will be described in detail with reference to accompanying drawings. The following embodiments do not restrict the present disclosure. All the combinations of features described in the following embodiments are not essential for solutions of the present disclosure. The same configurations are given the same reference numerals and the description thereof is omitted.

### First Embodiment

### <Hardware Configuration of Label Printing System>

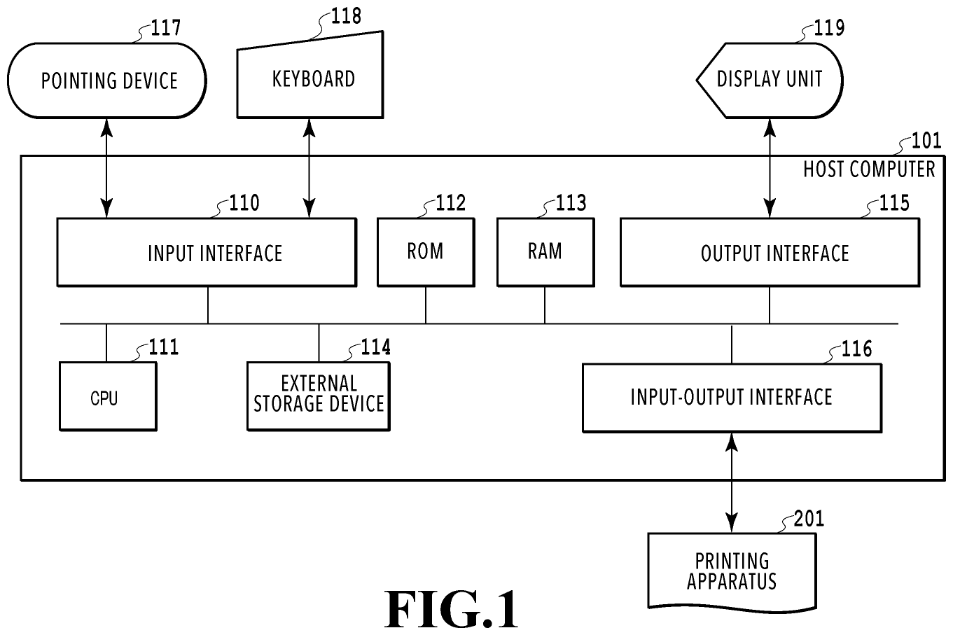

In the first embodiment, an example of a printing system used in a printing process for commercial printing will be described. FIG. 1 is a block diagram illustrating an example of the hardware configuration of the printing system. With reference to FIG. 1, the configuration of a host computer 101 will be described. The host computer 101 is an example of an information processing apparatus and includes an input interface 110, a central processing unit (CPU) 111, and a read only memory (ROM) 112. The host computer 101 includes a random-access memory (RAM) 113, an external storage device 114, an output interface 115, and an input-output interface 116. The input interface 110 is connected to input devices, such as a pointing device 117 and a keyboard 118. The output interface 115 is connected to a display device, such as a display unit 119.

The host computer 101 receives an input of control data from the pointing device 117 and/or the keyboard 118 through the input interface 110. The ROM 112 is a non-volatile storage medium and stores fixed data, including a control program to be executed by the CPU 111, an initial program, and an operating system (OS). The external storage device 114 stores various programs externally obtained, such as application programs and design applications, and other various data. The RAM 113 is a main memory of the CPU 111 and is used as a temporary storage area in which the programs stored in the ROM 112 and external storage device 114 are to be loaded. In the first embodiment, the CPU 111 performs processing according to procedures of the programs stored in the ROM 112 to execute processing concerning later-described functions and later-described flowcharts in the host computer 101.

The printing apparatus 201 is connected to the host computer 101 through the input-output interface 116. The host computer 101 sends to the printing apparatus 201, a later-described print job file, setting information concerning printing, or the like through the input-output interface 116. The host computer 101 may be connected to a plurality of the printing apparatuses 201. In the description of the first embodiment, the host computer 101 is configured separately from the printing apparatus 201 by way of example. However, the host computer 101 is not limited to such a configuration. For example, the host computer 101 and the printing apparatus 201 may be configured as one information processing apparatus. The host computer 101 may be a desk-top computer, a smartphone, or a notebook computer.

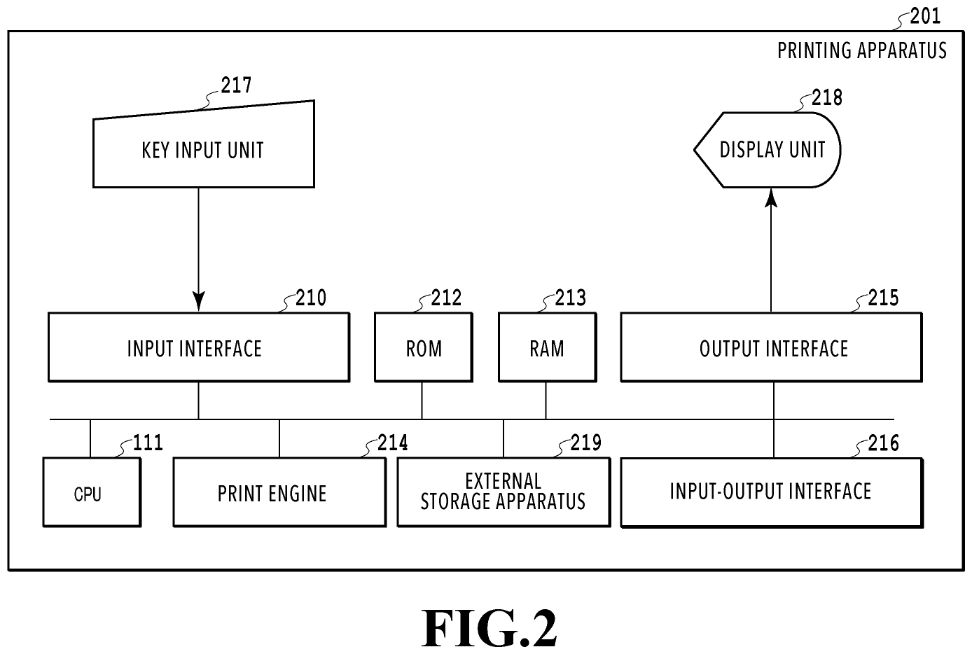

FIG. 2 is a block diagram illustrating an example of the hardware configuration of the printing apparatus 201. With reference to FIG. 2, the configuration of the printing apparatus 201 will be described. The printing apparatus 201 includes an input interface 210, a CPU 211, a ROM 212, and a RAM 213. The printing apparatus 201 includes a print engine 214, an output interface 215, an input-output interface 216, a key input unit 217, a display unit 218, and an external storage device 219. The key input unit 217 includes numerical input keys, a mode setting key, a determination key, a cancel key, and the like. The printing apparatus 201 accepts a user's operation from the key input unit 217 through the input interface 210. The display unit 218 is composed of a liquid crystal display (LCD) or the like and displays as image data, the detail of received print data and the state of the printing apparatus 201 through the output interface 215. The CPU 211 is a system controller and controls the entirety of the printing apparatus 201. The ROM 212 stores fixed data, including a control program to be executed by the CPU 211 and a data table. The external storage device 219 stores a print job file received from the host computer 101 and a print job ticket. The RAM 213 is used as a working memory of the CPU 211 and is also utilized as a buffer for temporarily storing a print job. The printing apparatus 201 may send to a server, a folder to be provided to the host computer 101, through the input-output interface 216. In a case where the host computer 101 shares folders stored in the server with the printing apparatus 201, the host computer 101 may obtain from the folder, necessary information for a later-described printing suitability determination process.

The print engine 214 forms an image on a print medium, such as paper, using a print agent, such as ink, based on data stored in the RAM 213, a print job file received from the host computer 101, and a print job ticket and outputs the result of printing. In the description of the first embodiment, the format of print job files is the portable document format (PDF) by way of example. The file format is not limited to PDF. The input-output interface 216 of the printing apparatus 201 is connected to the input-output interface 116 of the host computer 101 to implement mutual communication between the host computer 101 and the printing apparatus 201. The method of connecting the host computer 101 and the printing apparatus 201 can be, but is not limited to, for example, network connection or the like. In the description of the first embodiment, the printing apparatus 201 is an ink-jet printer performing printing by ejecting ink onto paper by way of example. However, printing may be executed by another method (for example, electrophotography).

### <Configuration of Printing Application>

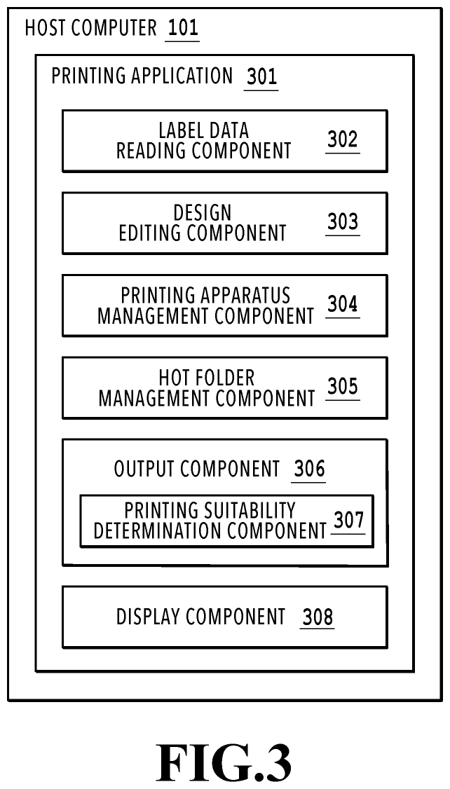

FIG. 3 is a diagram illustrating an example of the configuration of the printing application operating in the host computer 101. With reference to FIG. 3, the configuration of the printing application will be described. The printing application 301 includes a label data reading component 302, a design editing component 303, a printing apparatus management component 304, a hot folder management component 305, an output component 306, and a display component 308. The label data reading component 302 receives an instruction from the user and reads selected label data. The design editing component 303 accepts edits to decide the layout of the label data read by the label data reading component 302 on a recording medium, the color scheme of labels, and the like. The printing apparatus management component 304 obtains information (hereinafter, referred to as printer information) representing the current state of the printing apparatus. In the first embodiment, the printing apparatus management component 304 accepts settings of a shared folder (hereinafter, referred to as a printer information folder) registered in the printing apparatus 201. The printing apparatus management component 304 reads a file (hereinafter, referred to as a printer information file) which printer information is described in, from the set printer information folder and obtains the printer information. In the first embodiment, the printer information includes status information representing that the printing apparatus 201 is experiencing an error or is under maintenance, the presence or absence of a print medium loaded in the printing apparatus 201, and the presence or absence of ink loaded. The printer information also includes the width of the print medium loaded, the type of ink loaded, and the date and time when the printer information is updated by the printing apparatus 201 and may include other information. The printer information may be obtained by the host computer 101 that accepts specification of information indicating a printing apparatus itself (for example, the IP address) and performs direct communication with the printing apparatus. The printing apparatus management component 304 has a registration function that allows the printer information folder to be used repeatedly by storing in the printing application 301, the location of the printer information folder the specification of which was accepted, together with the name of the printing apparatus including the printer information folder. Hereinafter, the printer information folder is a folder which the printing application 301 refers to and the printer information is obtained from.

The hot folder management component 305 accepts registration of a hot folder provided by the printing apparatus 201 and obtains print settings (hereinafter, referred to as hot folder information) associated with the hot folder. The user is able to select a hot folder shared by the host computer 101 and the printing apparatus 201 and register the selected hot folder in a hot folder list held by the hot folder management component 305. The output component 306 includes a printing suitability determination component 307. The output component 306 outputs the print data edited by the design editing component 303 to the hot folder registered in the hot folder management component 305 or the external storage apparatus 114. The printing suitability determination component 307 determines whether the print data can be printed based on the hot folder information of the hot folder set as the storing destination of the print data and the printer information already obtained and notifies the user of whether the printing of the print data is suitable or not. The display component 308 displays a display screen, such as a user interface of the printing application 301, on the display unit 119.

### <Printing Application 301>

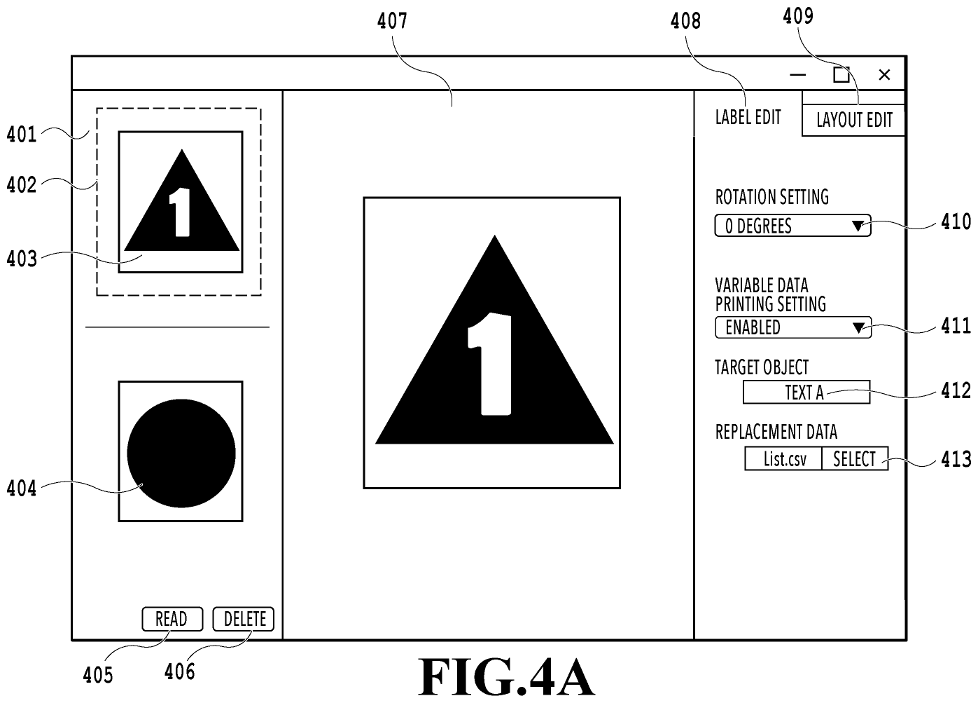

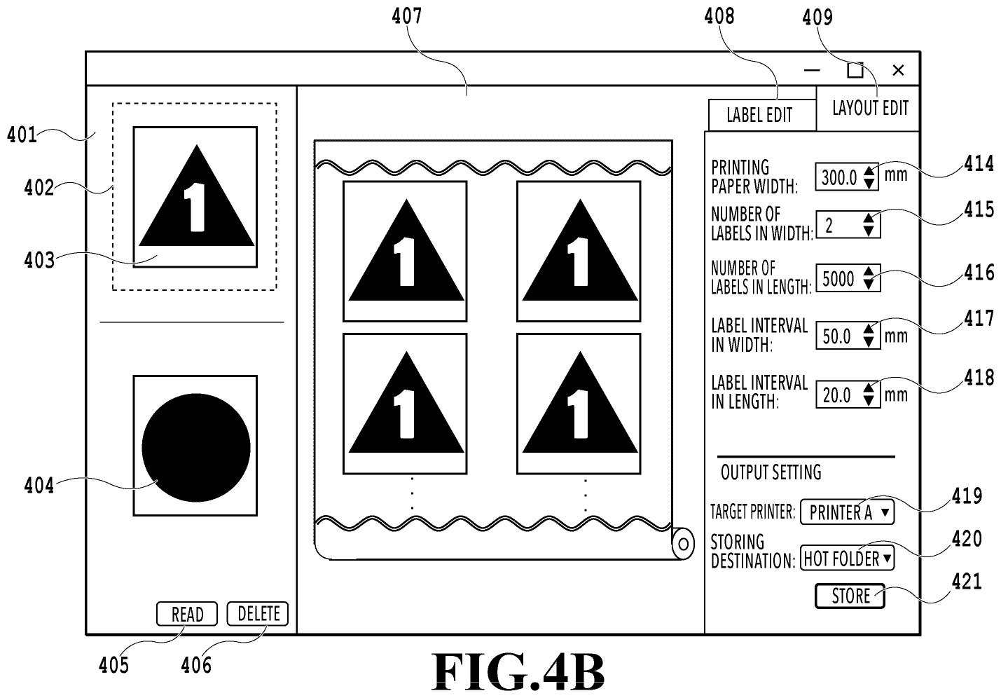

FIGS. 4A and 4B are diagrams illustrating an example of the user interface of the printing application 301. With reference to FIGS. 4A and 4B, the user interface (hereinafter, referred to as a printing application screen) of the printing application 301 will be described. The screen configuration, design, and setting items of the printing application 301 are not limited to this example. By user's operation, the printing application 301 from the printing application screen, accepts edits of label data and specification of the layout of labels on the print medium and outputs print data. In the first embodiment, setting information includes the label data, set on the printing application screen as illustrated in FIGS. 4A and 4B is referred to as first print setting information. The functions of the printing application 301 are not limited thereto.

The printing application screen includes a label data management area 401, a preview area 407, a label edit tab 408, and a layout edit tab 409. The label data management area 401 includes a read button 405 and a delete button 406. In the label data management area 401, label data 403, label data 404, and a selection frame 402 indicating that the label data 403 is selected are displayed. Upon the read button 405 being pressed by the user, the label data reading component 302 accepts an instruction to read label data. The label data reading component 302 displays thumbnails of the read label data in the label data management area 401. The format of label data to be read is, but is not limited to, the PDF or Illustrator file format by way of example in the first embodiment. The label data 403 and 404 are examples of label data that are read by the label data reading component 302 and are displayed in the label data management area 401. The user is able to select label data displayed in the label data management area 401 by operating the input device, such as the pointing device 117. For the selected label data, the selection frame 402 is displayed. The preview area 407 is a region in which to display label data. When the delete button 406 is pressed by the user while label data is selected (the selection frame 402 is displayed), the delete button 406 accepts removal of the selected label data from the label data management area 401.

FIG. 4A is a diagram illustrating an example of a printing application screen displayed in a case where the label edit tab 408 is selected. In the printing application screen, as illustrated in FIG. 4A, a rotation setting control 410, a variable data printing setting control 411, a target object selection control 412, and a replacement data selection control 413 are displayed. The rotation setting control 410 is able to accept selection of rotation angles in increments of 45 degrees, starting from 0 degrees, from a drop-down list and rotates the label data displayed in the preview area 407 according to the selection. The variable data printing setting control 411 accepts selection of whether to enable a variable data printing function. The variable data printing function refers to a function whereby the content of a specific object within label data is replaced with another specific content at the time of printing of each label. In a case where the variable data printing setting control 411 is set so as to enable the variable data printing function, the target object selection control 412 and the replacement data selection control 413 become active. The target object selection control 412 accepts inputs of the characters of the name of the object whose content is required to be replaced using the variable data printing function in the label data selected in the label data management area 401. For example, in a case where an object “1” in white within the label data 403 is defined as an object name “text A”, the target whose content is to be replaced can be specified by inputting “text A” in the target object selection control 412. The replacement data selection control 413 is able to accept data to be used in the replacement of the object specified by the target object selection control 412. Upon a selection button in the replacement data selection control 413 being pressed, a file selection dialog box for selecting files provided from the OS is displayed. The user is able to select, from the displayed file selection dialog, any data (for example, a csv file containing details of replacement data in the form of one record per label) that can be used in the replacement. The editing result after the setting in each setting item from the rotation setting control 410 to the replacement data selection control 413 is reflected on the label data selected in the label data management area 401. The label data reflecting the editing result is displayed in the preview area 407.

FIG. 4B is a diagram illustrating an example of the printing application screen displayed in a case where the layout edit tab 409 is selected. In the printing application screen, as illustrated in FIG. 4B, a printing paper width control 414, a number-of-labels-in-width control 415, a number-of-labels-in-length control 416, a label-interval-in-width control 417, and a label-interval-in-length control 418 are displayed. The setting items from the printing paper width control 414 to the label-interval-in-length control 418 accept inputs of setting values for setting the layout of the label data selected in the label data management area 401 on the print medium. In the printing application screen, a printing apparatus selection control 419, a storing destination selection control 420, and a storing button 421 are displayed. The setting items of the printing apparatus selection control 419 and the storing destination selection control 420 accept specification of the printing apparatus that shares folders with the host computer 101 and specification of a hot folder shared with the printing apparatus. When the layout edit tab 409 is in a selected state, the preview of the result from printing the label data selected in the label data management area 401 on the print medium (hereinafter, referred to as printing paper) is displayed in the preview area 407 based on the inputted layout values. Selecting the label edit tab 408 or the layout edit tab 409 switches the display between the setting items from the rotation setting control 410 to the replacement data selection control 413 and the setting items from the printing paper width control 414 to the storing destination selection control 420 and the storing button 421. Hereinafter, the setting items will be described in detail.

The printing paper width control 414 accepts an input of printing paper width as the setting contents in the printing application 301. In a case where the printer information obtained by the printing apparatus management component 304 exists within the printing application 301, the printing paper width control 414 reflects the printing paper width described in the printer information. The number-of-labels-in-width control 415 accepts an input of the number of labels laid-out in the printing paper width direction. The number-of-labels-in-length control 416 accepts an input of the number of labels laid-out in the printing paper length direction. The display in the preview area 407 is presented such that the user can visually recognize that plural sets of label data are laid-out in the printing paper length direction. For example, plural sets of label data may be displayed one after another in the preview area 407 by scrolling with the pointing device 117 or the like. The label-interval-in-width control 417 accepts an input of the interval between adjacent labels laid-out in the printing paper width direction. The label-interval-in-length control 418 accepts an input of the interval between adjacent labels laid-out in the printing paper length direction.

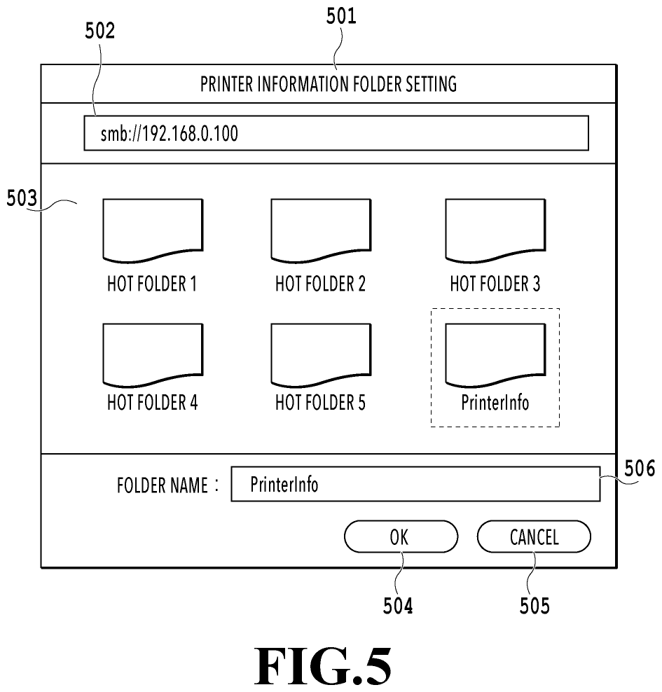

The printing apparatus selection control 419 accepts specification of a printer information folder as the source of printer information. In the printing apparatus selection control 419, the names of printing apparatuses including printer information folders shared with the host computer 101 are displayed. The user specifies a printer information folder by pressing the printing apparatus selection control 419 to select the name of the printing apparatus to be used. In a case where no printer information folder has been specified, the user is able to register a new printer information folder to a list or specify a printer information folder from the registered printer information folder list held by the printing apparatus management component 304. The printing apparatus selection control 419 displays in one drop-down list, the registered printer information folder list held by the printing apparatus management component 304 and a button to display a screen for registering a new printer information folder. In a case where a folder is selected from the registered printer information folder list, the printing apparatus selection control 419 sets the selected folder as a printer information folder. In a case where the button to display the screen for registering a printer information folder of a printing apparatus is pressed, the printing apparatus selection control 419 displays a printer information folder registration screen 501 as illustrated in FIG. 5.

FIG. 5 is a diagram illustrating an example of the printer information folder registration screen 501. With reference to FIG. 5, registration of a printer information folder to a list will be described. The printer information folder registration screen 501 includes a root folder display section 502, a folder display region 503, an OK button 504, a cancel button 505, and a folder name display section 506. In the first embodiment, the host computer 101 shares the folder storing the printer information of the printing apparatus 201 through the SMB protocol. For example, in a case where the IP address of the printing apparatus 201 connected to a network is “192.168.0.100”, URI “smb://192.168.0.100” indicating the protocol in a scheme is displayed in the root folder display section 502. That is, in the root folder display section 502, the root folder storing the printer information folder shared by the host computer 101 and the printing apparatus 201 and other shared folders is specified with a URI. In a case where the host computer 101 and the printing apparatus 201 share folders through a server, the URI containing an IP address of the server storing the printer information folder is displayed in the root folder display section 502.

In a case where the root folder is set in the root folder display section 502, accessible folders, including the printer information folder, under the root folder are listed in the folder display region 503. By the user selecting the printer information folder from the folders displayed in the folder display region 503, the name of the selected printer information folder is displayed in the folder name display section 506. Upon the OK button 504 being pressed, the printing apparatus management component 304 sets the selected printer information folder as the source of the printer information and adds the same to the printer information folder list held by the printing apparatus management component 304. Then, the printing application 301 closes the printer information folder registration screen 501 and performs display processing to return to the previous screen. Upon the cancel button 505 being pressed, the printing apparatus management component 304 does not register the printer information folder in the printer information folder list. Then the printing application 301 performs the same display processing as that performed upon the OK button 504 being pressed.

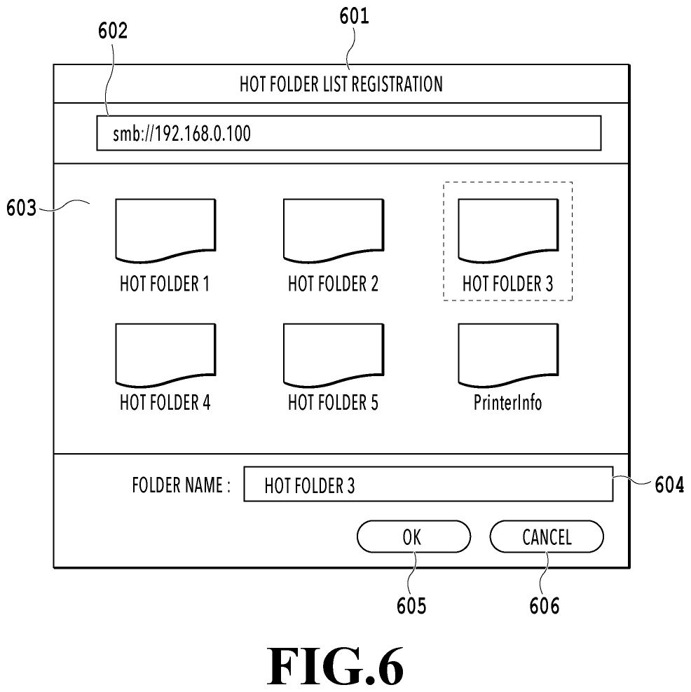

Back to FIG. 4B, the storing destination selection control 420 accepts specification of a hot folder intended to store the print data edited on the printing application screen. The storing destination selection control 420 displays in one drop-down list, a hot folder list held by the hot folder management component 305 and a button to display a screen for registering a new hot folder. In a case where a registered hot folder is selected, the storing destination selection control 420 sets the selected hot folder as the storing destination of the print data. In a case where the button to display a screen for registering a new hot folder is pressed, a hot folder list registration screen 601 is displayed as illustrated in FIG. 6. FIG. 6 is a diagram illustrating an example of the hot folder list registration screen 601. The hot folder registration screen 601 includes a root folder display section 602, a folder display region 603, a folder name display section 604, an OK button 605, and a cancel button 606. In the first embodiment, the host computer 101 shares plural hot folders registered in the printing apparatus 201 through the SMB protocol. For example, in a case where the IP address of the printing apparatus 201 connected to a network is “192.168.0.100”, URI “smb://192.168.0.100” indicating the protocol in a scheme is displayed in the root folder display section 602. In the root folder display section 602, the root folder storing the hot folders shared by the host computer 101 and the printing apparatus 201 and other shared folders is specified with a URI. In a case where the host computer 101 and the printing apparatus 201 share folders through a server, a URI containing the IP address of the server storing hot folders is displayed in the root folder display section 602.

In a case where the root folder is set in the root folder display section 602, accessible folders, including plural hot folders, under the root folder are listed in the folder display region 603. By the user selecting a hot folder to be registered from the folders displayed in the folder display region 603, the name of the selected hot folder is displayed in the folder name display section 604. Upon the OK button 605 being pressed, the hot folder management component 305 sets the selected hot folder as the storing destination of the print data and register the same in the hot folder list held by the hot folder management component 305. Then, the printing application 301 closes the hot folder registration screen 601 and performs display processing to return to the previous screen. Upon the cancel button 606 being pressed, the hot folder management component 305 does not register any hot folder in the hot folder list. Then the printing application 301 performs the same display processing as that performed upon the OK button 605 being pressed. In the storing destination selection control 420, the storing destination may be a folder (for example, a folder on the external storage device 114) other than hot folders.

Back to FIG. 4B, the storing button 421 accepts an output of print data reflecting edits made in the printing application screen, to the hot folder specified as the storing destination in the storing destination selection control 420. Herein, in the first embodiment, the storing button 421 becomes active in a case where a folder is set in the storing destination selection control 420. On the other hand, in a case where no folder is set in the storing destination selection control 420 or no hot folder is registered in the list, the storing button 421 becomes inactive and cannot accept output processing. However, the present disclosure is not limited thereto. For example, in a case where no folder is set in the storing destination selection control 420 or no hot folder is registered in the list, the folder as the storing destination may be a folder within the external storage device 114 of the host computer 101. Upon the storing button 421 being pressed with a folder set in the storing destination selection control 420, the printing suitability determination component 307 performs the printing suitability determination process.

### <Printing Suitability Determination Process>

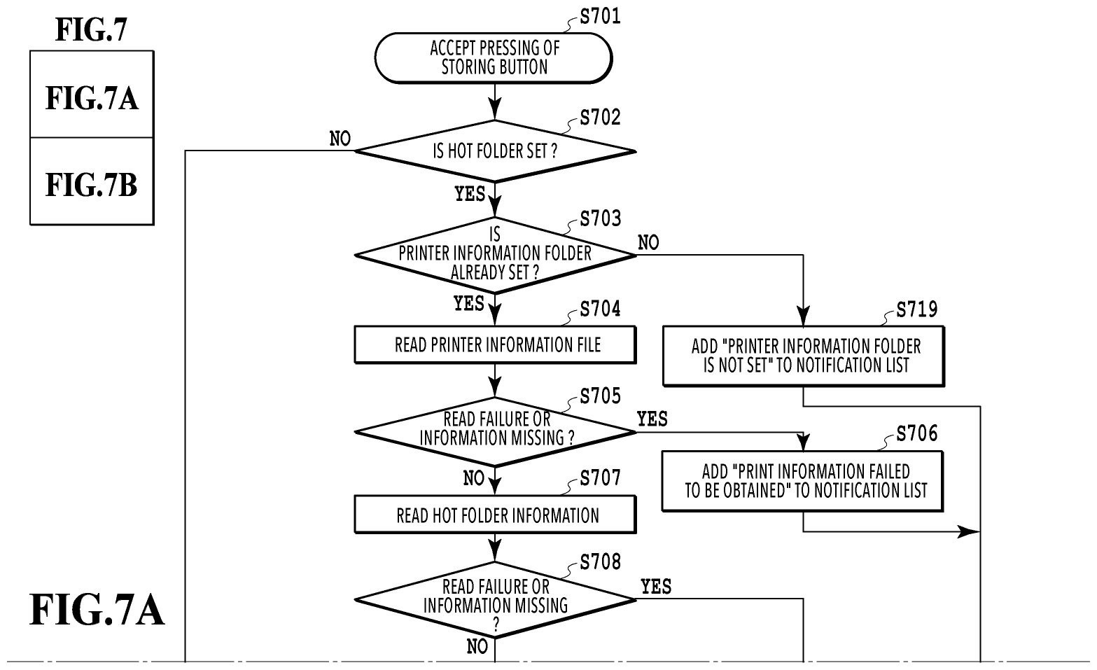

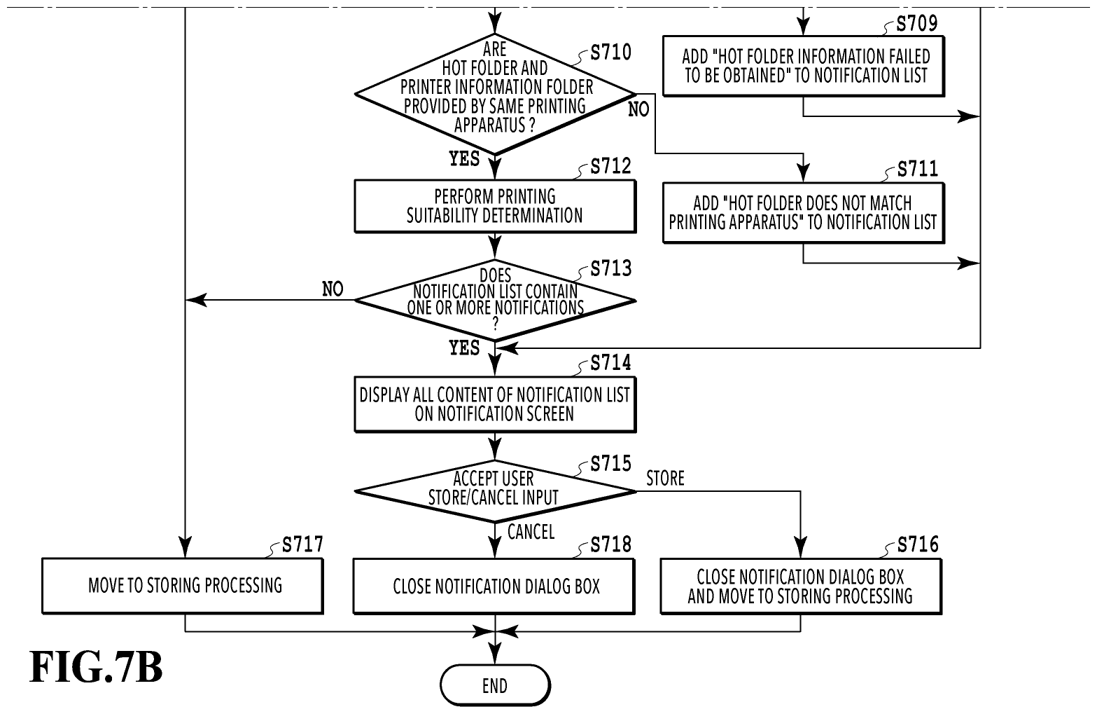

FIG. 7A and FIG. 7B are a flowchart illustrating an example of the printing suitability determination process performed by the printing suitability determination component 307. With reference to FIG. 7A and FIG. 7B, the printing suitability determination process will be described. The process illustrated in FIG. 7A and FIG. 7B is implemented by the CPU 111 of the host computer 101 loading a program stored in the ROM 112 or the like onto the RAM 113 and executing the same. The functions of a part or all of the steps in FIG. 7A and FIG. 7B may be implemented by hardware, such as an ASIC or an electronic circuit. Symbols “S” in the description of the process indicate steps in the flowchart (hereinafter, the same applies to flowcharts in the present specification). In S701, the printing suitability determination process is started upon the storing button 421 being pressed.

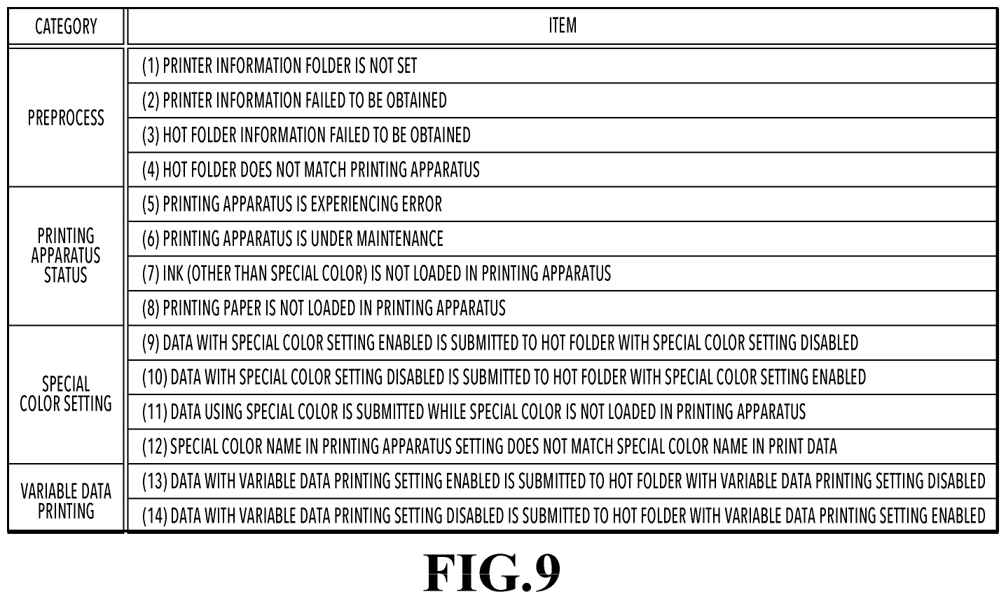

The printing suitability determination process includes a preprocess from S702 to S711 to determine whether all the information necessary for printing suitability determination is obtained and main processing for printing suitability determination in S712. FIG. 9 is a diagram illustrating an example of items to be determined in the printing suitability determination process. With reference to FIG. 9, the items to be determined in the printing suitability determination process will be described. In the first embodiment, the determination items are categorized into four: “preprocess”, “printing apparatus status”, “special color setting”, and “variable data printing”. The “preprocess” is a group of determination items intended to make a notification that all the information necessary for the printing suitability determination process has not been obtained yet. The “printing apparatus status” is a group of determination items intended to make a notification that the printing apparatus 201 is not in a ready state. The “special color setting” is a group of determination items intended to make a notification that the hot folder selected in the storing destination selection control 420 and/or print data being under the printing suitability determination are not in a suitable state for printing using special color. The “variable data printing” is a group of determination items intended to make a notification that the hot folder selected in the storing destination selection control 420 and/or print data being under the printing suitability determination are not in a suitable state for printing using the variable data printing function. In the preprocess from S702 to S711, four items of the “preprocess” in FIG. 9 are determined. In the main processing for printing suitability determination in S712, ten items of the “printing apparatus status”, “special color setting”, and “variable data printing” in FIG. 9 are determined. The suitability determination may be performed for another item depending on the functions of the printing apparatus 201 to be connected, setting items that can be applied to the hot folders provided by the printing apparatus 201, items that can be set in the printing application 301, or the like. Furthermore, the suitability determination does not need to be performed for all the determination items illustrated in FIG. 9.

Back to FIG. 7A, in S702, the CPU 111 determines whether a hot folder is set in the storing destination selection control 420. If the CPU 111 determines that a hot folder is set in the storing destination selection control 420 (Yes), the CPU 111 goes to processing in S703, and otherwise (No), the CPU 111 goes to processing in S717. Specifically, if the CPU 111 determines that the folder set in the storing destination selection control 420 is not a hot folder, the CPU 111 does not perform the subsequent determination processing and moves to storing processing in S717. The CPU 111 then terminates the printing suitability determination process. For example, if a folder stored in the external storage device 114 of the host computer 101 is set in the storing destination selection control 420, the CPU 111 stores the print data in the set folder in S717 and terminates the procedure illustrated in FIG. 7A and FIG. 7B.

In S703, the CPU 111 determines whether a printer information folder is set. If the CPU 111 determines that a printer information folder is set (Yes), the CPU 111 goes to processing in S704, and otherwise (No), the CPU 111 goes to processing in S719. In S719, the CPU 111 stores in a notification list, a notification that the suitability determination cannot be performed because no printer information folder is set. Herein, the notification list is a list in which all the results determined as unsuitable in the printing suitability determination process are stored temporarily and internally. The form of the notification list is, for example, a structure, an array, or the like and can be any form, as long as it can hold plural values together. The CPU 111 then goes to processing in S714. In S704, the CPU 111 reads a printer information file in the printer information folder to obtain printer information (second print setting information). The CPU 111 then goes to processing in S705. In S705, the CPU 111 determines whether the read printer information file includes missing parts or the printer information file has failed to be read. If the read printer information file includes missing parts or the printer information file has failed to be read (Yes), the CPU 111 goes to processing in S706, and otherwise (No), the CPU 111 goes to processing in S707.

In S706, the CPU 111 stores in the notification list, a notification that the suitability determination cannot be performed due to a failure in obtaining the printer information. The CPU 111 goes to processing in S714. In S707, the CPU 111 reads a hot folder information file stored in the hot folder set in the storing destination selection control 420 to obtain hot folder information (third print setting information). The CPU 111 then goes to processing in S708. In S708, the CPU 111 determines whether the hot folder information file includes missing parts or has failed to be read. If the CPU 111 determines that the hot folder information file includes missing parts or has failed to be read (Yes), the CPU 111 goes to processing in S709, and otherwise (No), the CPU 111 goes to processing in S710. In S709, the CPU 111 stores in the notification list, a notification that the suitability determination cannot be performed due to a failure in obtaining the hot folder information. The CPU 111 then goes to processing in S714.

In S710, the CPU 111 determines whether the hot folder set as the storing destination of the print data is provided by the same printing apparatus that provides the printer information folder. If the CPU 111 determines that the hot folder is provided by the same printing apparatus (Yes), the CPU 111 goes to processing in S712, and otherwise (No), the CPU 111 goes to processing in S711. In the first embodiment, the source printing apparatus that provide the hot folder and the source printing apparatus that provides the printer information folder are determined using the IP addresses of the route folders. However, the determination method is not limited to by the IP addresses. For example, the determination method may be matching using printing apparatus-specific identification information embedded in the hot folder information and the printer information.

In S711, the CPU 111 stores in the notification list, a notification that the suitability determination cannot be performed because the set hot folder does not match the set printer information file. The CPU 111 then goes to processing in S714. In S712, the CPU 111 performs the main processing for printing suitability determination process. After the printing suitability determination is completed for all the items, the CPU 111 goes to processing in S713. In S713, the CPU 111 checks whether the notification list includes the results determined unsuitable. If the CPU 111 determines that the notification list includes one or more notifications (Yes), the CPU 111 goes to processing in S714, and otherwise (No), the CPU 111 goes to processing in S717. In a case where the notification list does not include any notification and none of the items is determined unsuitable, the CPU 111 performs storing processing in S717 and terminates the printing suitability determination process. That is, the CPU 111 stores the print data in the set hot folder as a print job file.

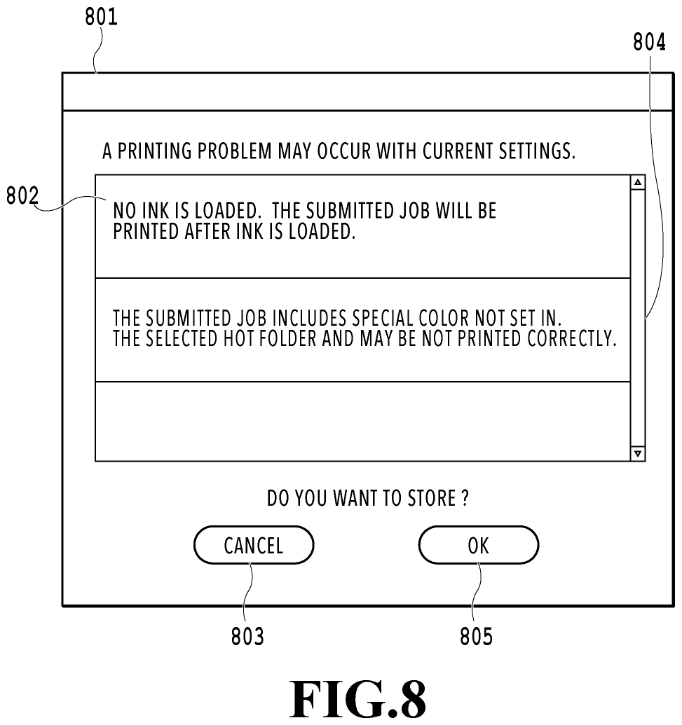

In S714, the CPU 111 displays all the determination results in a notification screen (hereinafter, referred to as a notification dialog box). Specifically, as illustrated in FIG. 8, the CPU 111 displays all the contents of the notification list in the notification dialog box. FIG. 8 is a diagram illustrating an example of the dialog box that makes a notification of the results of the printing suitability determination process. With reference to FIG. 8, the notification dialog box will be described. The notification dialog box 801 includes a notification display area 802, a cancel button 803, a scroll bar 804, and an OK button 805. The notification dialog box 801 is a dialog box that displays a message corresponding to the determination results within the notification list. In the notification display area 802, messages corresponding to the determination results within the notification list are displayed. In this process, in a case where there are plural messages to be displayed, these messages are displayed in the same notification display area with clear separation therebetween. In a case where the notification list cannot be fully displayed within the notification display area 802, the user is able to check the messages by operating the scroll bar 804. The cancel button 803 and OK button 805 accept the selection of whether to store the messages.

Back to FIG. 7B, in S715, the CPU 111 accepts a user's input for the notification dialog box 801. If the CPU 111 determines that the OK button 805 is pressed (Yes), the CPU 111 goes to processing in S716, and if the CPU 111 determines that the cancel button 803 is pressed (No), the CPU 111 goes to processing in S718. In S716, the CPU 111 closes the notification dialog box 801. The CPU 111 then moves to the storing processing and terminates the printing suitability determination process. In this case as well, the CPU 111 stores the print data in the set hot folder as a print job file. In S718, the CPU 111 closes the notification dialog box 801. The CPU 111 then terminates the printing suitability determination process without performing the storing processing. The CPU 111 discards the contents of the notification list at the process of closing the notification dialog box 801 in processing in both S716 and S718.

### <Main Processing for Printing Suitability Determination>

With reference to FIG. 9, the main processing for printing suitability determination performed in S712 will be described. The items of the “printing apparatus status”, “special color setting”, and “variable data printing” in FIG. 9 are determined in parallel.

The CPU 111 performs the printing suitability determination for the four items categorized into the “printing apparatus status” in FIG. 9 with reference to the printer information file obtained in S704. Specifically, for item (5) in FIG. 9, the CPU 111 refers to the status information described in the printer information file. If the status information includes the description of an error, the CPU 111 stores in the notification list, a notification that the submitted job will not be printed promptly because the printing apparatus is experiencing an error. For item (6) in FIG. 9, if the status information includes the description of maintenance, the CPU 111 stores in the notification list, a notification that the submitted job will not be printed promptly because the printing apparatus is under maintenance. For item (7) in FIG. 9, the CPU 111 refers to ink settings described in the hot folder information file and ink information described in the printer information file. If the CPU 111 determines that process color ink described in the ink settings is not loaded in the printing apparatus 201, the CPU 111 stores in the notification list, a notification that ink is not loaded in the printing apparatus. For item (8) in FIG. 9, the CPU 111 refers to the settings of printing paper loaded in the printing apparatus 201, which are described in the printer information file. If the CPU 111 determines that the printer information file does not include any description of setting values of the printing paper settings or includes the description that printing paper is not loaded, the CPU 111 stores in the notification list, a notification that printing paper is not loaded in the printing apparatus 201. By completing all the aforementioned determinations, the printing suitability determination for the printing apparatus status finishes.

Next, items (13) and (14) will be described. Items (9) to (12), which are categorized into the “special color setting”, will be described later. For the two items categorized into the “variable data printing” in FIG. 9, the CPU 111 performs the printing suitability determination with reference to the hot folder information file obtained in S707 and the contents of the print data to be currently stored. For item (13) in FIG. 9, the CPU 111 determines whether the print data to be currently stored has a variable data printing setting disabled and the variable data printing setting of the hot folder information file includes the description that variable data printing is to be used. If the CPU 111 determines that such conditions apply, the CPU 111 stores in the notification list, a notification that print data with a variable data printing setting disabled will be submitted to a hot folder with a variable data printing setting enabled. For item (14) in FIG. 9, the CPU 111 determines whether the print data to be currently stored have a variable data printing setting enabled and the variable data printing setting of the hot folder information file includes the description that variable data printing is not to be used. If the CPU 111 determines that such conditions apply, the CPU 111 stores in the notification list, a notification that print data with a variable data printing setting enabled will be submitted to a hot folder with a variable data printing setting disabled. By completing all the aforementioned determinations, the printing suitability determination for the variable data printing finishes.

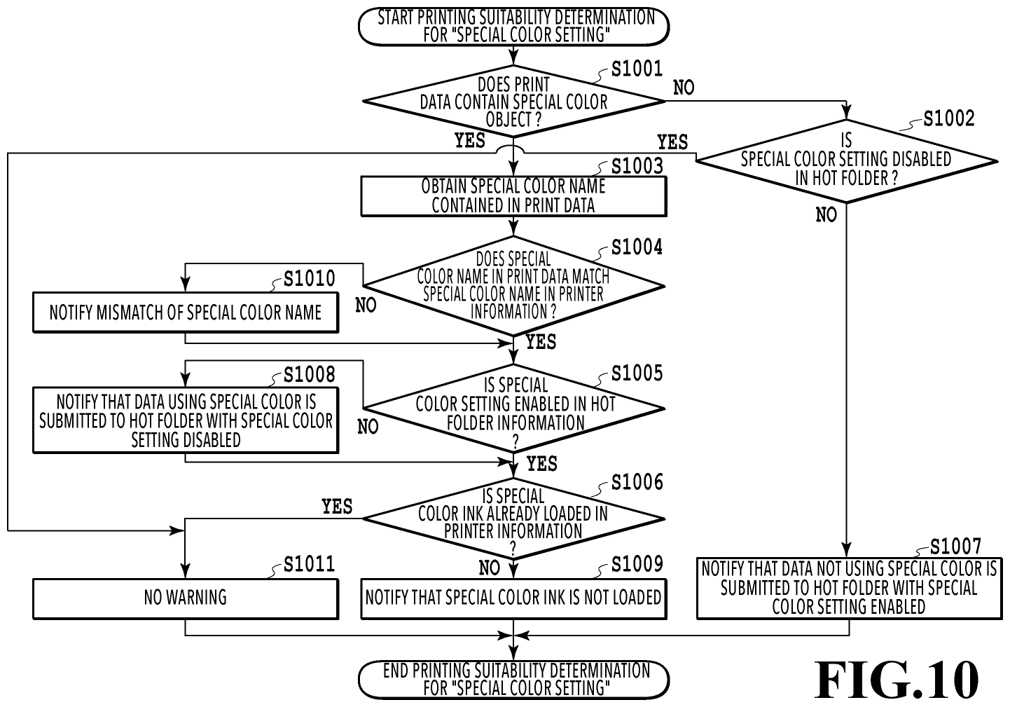

For the four items categorized into the “special color setting” in FIG. 9, the CPU 111 performs the printing suitability determination with reference to the printer information file obtained in S704, the hot folder information file obtained in S707, and the contents of the print data to be currently stored. FIG. 10 is a flowchart illustrating an example of the printing suitability determination process. With reference to FIG. 10, the printing suitability determination for special color settings will be described.

In S1001, the CPU 111 determines whether the print data to be currently stored includes color information indicating special color. If the CPU 111 determines that the print data includes the color information (Yes), the CPU 111 goes to processing in S1003, and otherwise (No), the CPU 111 goes to processing in S1002. In the first embodiment, the CPU 111 analyzes the file configuration of the PDF file and determines whether the print data includes the color information, based on the object extracted from the PDF file, the analysis information, and the like. However, the present disclosure is not limited thereto. That is, the determination may be performed by any method, as long as it is able to determine that the print data includes the color information.

In S1002, the CPU 111 determines whether the special color setting described in the hot folder information file is disabled. If the CPU 111 determines that the special color setting is disabled (Yes), the CPU 111 goes to processing in S1011, and otherwise (No), the CPU 111 goes to processing in S1007. In S1011, the CPU 111 terminates the printing suitability determination concerning the special color setting. In S1007, the CPU 111 stores in the notification list, a notification that the print data with a special color setting disabled is submitted to a hot folder with a special color setting enabled (corresponding to item (10) in FIG. 9) and terminates the printing suitability determination concerning the special color settings.

In S1003, the CPU 111 obtains the name (hereinafter, referred to as a special color name) of special color contained in the print data to be stored. This is because the printing apparatus 201 in the first embodiment determines portions using special color in the print data, by using an object specifying special color and the special color name set for the object. The CPU 111 then goes to processing in S1004.

In S1004, the CPU 111 refers to the item described in the printer information file concerning the special color name set in the printing apparatus 201 and determines whether the special color name in the printer information file matches the special color name obtained in S1003. If the CPU 111 determines that the special color name set for the printing apparatus 201 matches the special color name obtained in S1003 (Yes), the CPU 111 goes to processing in S1005, and otherwise (No), the CPU 111 goes to processing in S1010. In S1010, the CPU 111 stores in the notification list, a notification that the name of the special color indicated by the color information included in the print data does not match the special color name set in the printing apparatus 201 (corresponding to item (12) in FIG. 9). Then the CPU 111 continues the printing suitability determination process and goes to S1005.

In S1005, the CPU 111 determines whether the special color setting described in the hot folder information file is enabled. If the CPU 111 determines that the special color setting is enabled (Yes), the CPU 111 goes to processing in S1006, and otherwise (No), the CPU 111 goes to processing in S1008. In S1008, the CPU 111 stores in the notification list, a notification that print data using special color will be submitted to a hot folder with a special color setting disabled (corresponding to item (9) in FIG. 9). Then the CPU 111 continues the printing suitability determination process and goes to processing in S1006.

In S1006, the CPU 111 determines whether the special color ink described in the ink settings of the hot folder information file is in a loaded state in the ink setting described in the printer information file. If the CPU 111 determines that the special color ink in the hot folder information file is in a loaded state in the ink setting described in the printer information file (Yes), the CPU 111 goes to processing in S1011, and otherwise (No), the CPU 111 goes to processing in S1009. In S1009, the CPU 111 stores in the notification list, a notification that the print data using special color will not be printed because the special color ink is not loaded (corresponding to item (11) in FIG. 9) and terminates the printing suitability determination concerning the special color settings. After completing the printing suitability determination for all the aforementioned “printing apparatus status”, “special color setting”, and “variable data printing, the CPU 111 performs processing in S713 and subsequent steps in FIG. 7B.

As described above, according to the first embodiment, the user is notified that the print data to be printed is likely not to be printed as expected with a hot folder in which the print data is to be submitted and the current state of the printing apparatus corresponding to the hot folder. This can reduce user's printing error.

### Second Embodiment

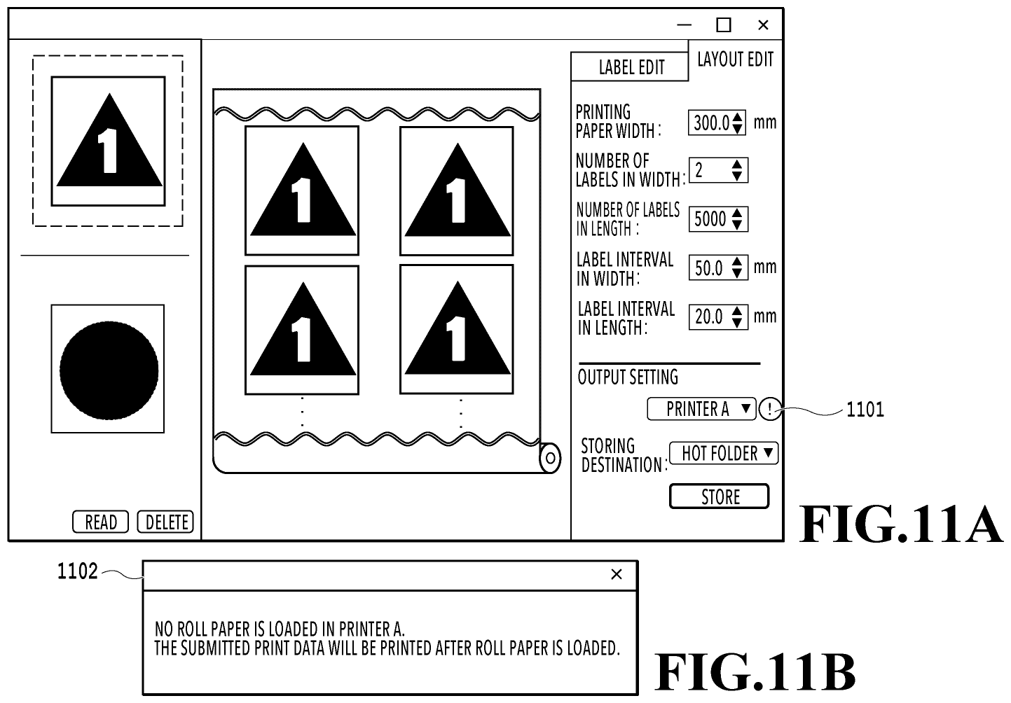

As a second embodiment, a mode will be described in which the results of printing suitability determination can be checked on the printing application screen even after the notification dialog box 801 is closed. The configuration and the processing until S715 in the second embodiment are the same as those of the aforementioned embodiment, and the description thereof is omitted. In the aforementioned embodiment, at the moment the user attempts to resolve portions that could be factors preventing printing, of which the notification dialog box 801 has notified, on the printing application screen, the notification dialog box 801 is already closed. That is, to check again the portions that could be factors preventing printing, it is necessary for the printing application 301 to perform the printing suitability determination process and then for the user to press the store button 421 again with the same settings. In the second embodiment, therefore, the printing application 301 accepts an input of the cancel button 803 in S715 and holds the contents of the notification list without discarding the same at the process of closing the notification dialog box 801 in S718. As illustrated in FIGS. 11A and 11B, the display component 308 then displays the notification dialog box displaying the contents of the notification list and an indication item at the position corresponding to the contents of the notification list on the printing application screen.

FIGS. 11A and 11B are diagrams illustrating an example of indication items that make a notification of the result of the printing suitability determination process. With reference to FIGS. 11A and 11B, the description will be given of a case where the notification list includes a notification that printing paper is not loaded in the printing apparatus 201 by way of example. FIGS. 11A and 11B illustrate a notification icon 1101, which is the indication item displaying on the printing application screen, and a notification detail dialog box 1102, which is a display screen displaying the contents of the notification list. On the printing application screen, the notification icon 1101 is displayed near the setting item that relates to the contents of a notification stored in the notification list. Specifically, in FIG. 11A, the notification icon 1101 is displayed to the side of the printing apparatus election control 419, which relates to the contents of the notification that printing paper is not loaded in the printing apparatus 201. Upon the notification icon 1101 being pressed, the notification detail dialog box 1102, which displays the detail of the notification, is displayed. The message displayed in the notification detail dialog box 1102 is the same as the corresponding one of the messages displayed in the notification dialog box 801 in S714.

The notification icon 1011 is displayed at a position fixed for each determination item illustrated in FIG. 9 and will not be located dynamically. Even in a case where there are plural notifications corresponding to one setting item on the printing application screen, one notification icon 1101 is displayed, and plural messages are displayed in the notification detail dialog box 1102. The notification list that has been held is discarded just before the printing suitability determination process is executed upon the store button 421 being pressed next time. As described above, according to the second embodiment, in addition to the effect described in the first embodiment, the user is able to check portions that could be factors preventing printing even after the notification dialog box is closed. It is therefore possible to improve the convenience of the user doing the work of resolving factors that prevent printing.

### Third Embodiment

As a third embodiment, the printing suitability determination process will be described in a case where the printing apparatus 201 does not provide a hot folder information file. The same contents as those of the aforementioned embodiments are omitted. In a certain case, the printing application 301 of the host computer 101 that shares a folder provided by the printing apparatus 201 is able to obtain printer information from the printer information folder but is not able to obtain hot folder information from a hot folder. For example, in a printing apparatus, the technique to update one printer information file and provide printer information and the technique to update a lot of hot folder information files and provide hot folder information are different in technical difficulty level in some cases. That is, the printing apparatus provides a printer information folder in a form that can be interpreted by the printing application 301 of the host computer 101 but does not provide hot folder information in a form that can be interpreted by the printing application 301. In some cases, thus, the hot folder information file cannot be obtained from a hot folder depending on the ability of the printing application 301 or the functions of the printing apparatus 201. In such a case, the printing application 301 has difficulty in obtaining hot folder information. In the third embodiment, therefore, the hot folder registration process of the hot folder management component 305 is configured to have a function to accept inputs of print settings to be applied to the hot folder to be registered.

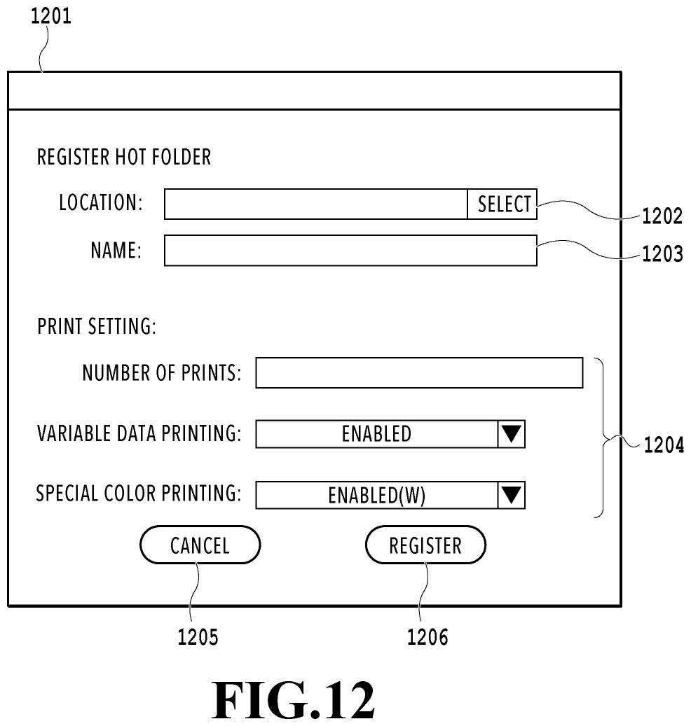

FIG. 12 is a diagram illustrating an example of a hot folder registration screen 1201 displayed by the hot folder management component 305 in the third embodiment. The hot folder registration performed by the user on the printing application 301 will be described with reference to FIG. 12. The hot folder registration screen 1201 includes a hot folder selection control 1202, a name setting control 1203, a print setting control group 1204, a cancel button 1205, and a registration button 1206. The hot folder registration screen 1201 is a dialog box that is displayed in response to pressing a button to perform hot folder registration on the printing application 301 (for example, a hot folder registration button in the storing destination selection control 420).

The hot folder selection control 1202 is an item whereby a folder to be registered is selected from hot folders provided by the printing apparatus 201. Herein, the printing application 301 is able to obtain a network path (hereinafter, referred to as a path) linked to the selected hot folder even in a case where the printing application 301 is not able to obtain the hot folder information from the hot folder provided by the printing apparatus 201. In response to pressing the selection button of the hot folder selection control 1202, the hot folder management component 305 displays a screen for selecting a hot folder as illustrated in FIG. 6 and accepts user's selection. When a hot folder is selected and the OK button is pressed, the selection screen is closed, and the printing application 301 obtains the path linked to the selected hot folder. The name setting control 1203 accepts an input of any name for the hot folder to be registered. The print setting control group 1204 accepts the print settings linked to the hot folder selected in the hot folder selection control 1202. The setting controls included in the print setting control group 1204 are not limited to those illustrated in FIG. 12. For example, the setting controls include setting controls for all the items that can be applied to a hot folder depending on the specifications of the printing apparatus 201. If the cancel button 1205 is pressed, the hot folder management component 305 does not register a hot folder. The hot folder management component 305 performs processing to close the hot folder registration screen 1201. If the registration button 1206 is pressed, the hot folder management component 305 registers a new hot folder. In this process, the hot folder management component 305 stores in the printing application 301, the print settings accepted in the print setting control group 1204 in association with the location of the hot folder and the name information. As a storage form of the print settings, the print settings may be stored as a single file, and the path thereof may be registered in association with the location and name of the hot folder. As another storage form of the print settings, the location, the name, and the contents of each print setting of the hot folder are stored as a single information group.

The printing suitability determination process in the third embodiment is performed according to the same procedure as that of the first embodiment in FIG. 7A and FIG. 7B, and the description thereof is omitted. In the process of reading the hot folder information in S707, the CPU 111 does not obtain the hot folder information file stored in the hot folder on the printing apparatus 201 and refers to the print settings that are registered on the hot folder registration screen 1201 and are stored within the printing application 301. In the processing in S708 and subsequent steps and the procedure in FIG. 10, the CPU 111 performs the printing suitability determination by using the print settings obtained in S707 as the hot folder information. As described above, according to the third embodiment, it is possible to obtain the same effects as those of the first embodiment even in a case where the printing apparatus does not provide hot folder information files.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-139930, filed Aug. 30, 2023, which is hereby incorporated by reference herein in its entirety.

What is claimed is:

1. An information processing method comprising:
an obtaining step of obtaining print data containing first print setting information representing setting information of printing, second print setting information representing a current print setting in a printing apparatus intended to print the print data, and third print setting information applied to a hot folder corresponding to the printing apparatus; and
a notification step of making a predetermined notification based on the first print setting information, the second print setting information, and the third print setting information.

2. The information processing method according to claim 1, wherein
the predetermined notification is a notification indicating whether printing of the print data in the printing apparatus is suitable or not.

3. The information processing method according to claim 1, wherein
in the obtaining step, the third print setting information is obtained in a case where the hot folder is set as a storing destination folder.

4. The information processing method according to claim 1, wherein
in the obtaining step, the second print setting information is obtained in a case where a folder including the second print setting information provided by the printing apparatus is set.

5. The information processing method according to claim 1, wherein
in a case where printing of the print data is unsuitable due to plural factors, in the notification step, the predetermined notification includes the plural factors.

6. The information processing method according to claim 1, wherein
in the obtaining step, the third print setting information is obtained from a hot folder information file stored in the hot folder.

7. The information processing method according to claim 1, further comprising
a step of accepting an input of print setting information to be applied to the hot folder in a case where the third print setting information cannot be obtained from the hot folder in the obtaining step.

8. The information processing method according to claim 7, further comprising
a determination step of determining based on the inputted print setting information whether printing of the print data in the printing apparatus is suitable or not.

9. The information processing method according to claim 2, wherein
in the notification step, a notification of being unsuitable for printing of the print data in the printing apparatus is made through a notification screen, the method further comprising
an accepting step of accepting storing of the print data in the hot folder from the notification screen, wherein
in a case where the storing is not accepted in the accepting step, an indication item to make a notification of being unsuitable for the printing is displayed in the notification step.

10. The information processing method according to claim 1, wherein
the print setting information of the first to third print setting information includes information concerning a special color setting.

11. The information processing method according to claim 1, wherein
in a case where the print data includes information concerning special color, in the obtaining step, information concerning the special color setting of the first print setting information is obtained.

12. The information processing method according to claim 1, wherein
in a case where the print data includes information concerning special color and the third print setting information has a special color setting enabled, in the notification step, a notification of being unsuitable for printing of the print data in the printing apparatus is made.

13. The information processing method according to claim 1, wherein
in a case where information concerning special color included in the first print setting information does not match information concerning special color set in the second print setting information, in the notification step, a notification of being unsuitable for printing of the print data in the printing apparatus is made.

14. An information processing apparatus comprising:
at least one memory and at least one processor which function as:
an obtaining unit configured to obtain print data containing first print setting information representing setting information of printing, second print setting information representing a current print setting in a printing apparatus intended to print the print data, and third print setting information applied to a hot folder corresponding to the printing apparatus; and
a notification unit configured to make a predetermined notification based on the first print setting information, the second print setting information, and the third print setting information.

15. A non-transitory computer readable storage medium storing a program for causing a computer to preform:
obtaining print data containing first print setting information representing setting information of printing, second print setting information representing a current print setting in a printing apparatus intended to print the print data, and third print setting information applied to a hot folder corresponding to the printing apparatus; and
making a predetermined notification based on the first print setting information, the second print setting information, and the third print setting information.
